(19) United States
(12) Patent Application Publication
(10) Pub. No.: US 2013/0003168 A1
(43) Pub. Date: Jan. 3, 2013

(54) Infrared Zoom Lens

(75) Inventor: Koji Kawaguchi, Saitama (JP)

(73) Assignee: TAMRON CO., LTD., Saitama (JP)

(21) Appl. No.: 13/537,864

(22) Filed: Jun. 29, 2012

(30) Foreign Application Priority Data
Jul. 1, 2011 (JP) 2011-147467

(51) Int. Cl. G02B 13/14

(52) U.S. Cl. 359/356

(57) ABSTRACT

The present invention is directed to an infrared zoom lens that is adapted to have a reduced number of lens pieces and that is especially capable of holding field curvature and spherical aberration down on developing more during zooming. The infrared zoom lens comprises the first lens of a single positive-powered lens piece, the second lens of a single negative-powered lens piece, and the third lens of a single positive-powered lens piece where all the lens pieces are spherical lenses; and the infrared zoom lens has its first lens staying still in a fixed position and its second and third lens moved along the optical axis for the zooming.

### FIELD OF THE INVENTION

The present invention relates to an infrared zoom lens, and more particularly, to an infrared zoom lens adapted to transmit infrared rays and attain clear imaging so as to be suitably used for infrared thermography, surveillance cameras, and the like. The term ‘infrared rays’ means radiated beams of light ranging from intermediate infrared radiation of 3000 to 5000 nm wavelength range to far infrared radiation of 8000 to 14000 nm wavelength range.

### BACKGROUND OF THE INVENTION

Detectors and vidicons, which sense IR radiations typically of medical or industrial use, especially, far IR radiations of 10000 nm wavelength or slightly higher or lower, are poor in sensitivity. IR transmitting materials such as germanium used for these optical devices generally have lower transmissivity than the ordinary optical lenses. Thus, optics of the above-mentioned optical devices for sensing are required to be relatively bright, as you may speak, having a reduced aperture ratio. Meanwhile, zooming/focusing lenses are advantageous in that they are significantly handy in simply varying a focal length to achieve a varied magnification power, but instead, they have a disadvantage that with an increased number of component lens pieces and thus an increased number of lens surfaces, they absorb and/or reflect light more.

In one prior art exemplary infrared lens that is dedicated to optics for transmitting infrared rays of wavelength band ranging from 3000 to 5000 nm or from 8000 to 12000 nm, there are five of groups of lens pieces arranged in sequence, namely, the foremost or first lens group of one or two lens pieces and of positive refractive power, the second foremost or second lens group of one or two lens pieces and of negative refractive power, the succeeding third lens group of a single negative-powered meniscus lens having its concave surface directed to an object, the trailing fourth lens group of a single convex lens, and the rearmost or fifth lens group of four or more lens pieces and of positive refractive power, with the lens piece the closest to an imaging plane being a positive-powered meniscus lens having its convex surface directed to the object. During zooming, the infrared zoom lens has its first, fourth and fifth lens groups staying still in their respective fixed positions and second and third lens groups moved in a manner that the second lens group is displaced along the optical axis to vary magnification power while the third lens group is displaced along the optical axis to correct an imaging position. The infrared zoom lens is optically configured to meet the requirements as defined in the following formulae (1) to (3):

1.00<f₁/fₜ (1)

f₂/fₜ<−0.40 (2)

0.35<f₅/fₜ<0.70 (3)

where fₜ is a focal length of the entire optics of the zoom lens deployed in telephoto end, f₁ is the focal length of the first lens group, f₂ is the focal length of the second lens group, and f₅ is the focal length of the fifth lens group (see Patent Document 1 listed below).

In another prior art exemplary infrared lens that is not a zoom lens but simply serves as an infrared lens, and that is of a cost-reduction oriented design and still yet widens a field angle up to approximately 30 degrees as well as ensuring a sufficient back focus relative to a focal length so as to implement an enhanced optical performance for transmitted beams of wavelength band ranging from 7000 to 14000 nm, there are four of optical components arranged in sequence, namely, the foremost or first lens piece L1 shaped in positive-powered meniscus with its convex surface directed to an object, an aperture stop, the second lens piece L2 shaped in negative-powered meniscus with its concave surface directed to the object, and the rearmost or third lens piece L3 shaped in positive-powered meniscus with its convex surface directed to the object. The infrared lens meets the requirements as defined in the following formulae (4) and (5):

0.4<|r4|/f<0.82 (4)

0.9<(|r4|+d4)/|r5|<1.10 (5)

where f is a focal length of the entire optics, r4 is a radius of curvature of a front surface of the second lens piece L2 closer to the object, r5 is the radius of curvature of a rear surface of the second lens piece L2 closer to an imaging plane, and d4 is a thickness of the second lens piece L2 in its center (see Patent Document 2 listed below).

### LIST OF THE CITED DOCUMENTS OF THE PRIOR ART

### Patent Document 1

Official Gazette of Japanese Patent No. 3365606

### Patent Document 2

Official Gazette of Preliminary Publication of Unexamined Japanese Patent Application No. 2010-039243

### SUMMARY OF THE INVENTION

The infrared zoom lens described in Patent Document 1 has, in some aspects, eight to twelve lens pieces which unavoidably increases dimensions of the lens optics, as a whole, and also increases light absorption by the lens pieces. In addition, chromatic aberration for transmitted beams within a wavelength band ranging from 10000 nm to slightly above and below is developed, and thus, when the infrared zoom lens is used for transmitting infrared radiations of approximately 10000 nm in wavelength, there arises a disadvantage that imaging performance is degraded.

The infrared lens described in Patent Document 2 has the reduced number of the lens pieces down to three, which enables the infrared lens to be downsized and reduced in weight, but it cannot serve as an infrared zoom lens.

The present invention is made to overcome the aforementioned disadvantages of the prior art infrared lenses, and accordingly, it is an object of the present invention to provide an infrared zoom lens adapted to have a reduced number of lens pieces.

It is another object of the present invention to provide an infrared zoom lens that is especially capable of holding field curvature and spherical aberration down on developing more during zooming.

### SUMMARY OF THE INVENTION

The present invention provides an infrared zoom lens comprising the first lens of a single positive-powered lens piece, the second lens of a single negative-powered lens piece, and the third lens of a single positive-powered lens piece where all the lens pieces are spherical lenses; and the infrared zoom lens has its first lens staying still in a fixed position and its second and third lens moved along the optical axis for the zooming.

In accordance with the present invention, the infrared zoom lens adapted to have a reduced number of lens pieces can be provided. Also, in accordance with the present invention, the infrared lens adapted to avoid field curvature and spherical aberration developing more because of the zooming can be provided.

In one aspect of the present invention, the infrared zoom lens meet the requirement as defined in the following formula (6):

f1/ft<1.5 (6)

where f1 is a focal length of the first lens, and ft is the focal length of the entire optics during the telephotographing.

The formula (6) defines a condition in which the lens optics, as a whole, can be downsized. If f1/ft exceeds a higher limit defined in the formula (1), the second and third lenses have to have their respective diameters increased to adversely result in the entire lens optics increasing in lengthwise dimension.

In another aspect of the present invention, the infrared zoom lens meets the requirements as defined in the following formula (7):

1.0<(d2t−d2w)/(ft−fw)<1.5 (7)

where d2t is a distance from the first lens to the second lens during the telephotographing, d2w is the distance from the first lens to the second lens during the wide-angle photographing, ft is a focal length of the entire optics during the telephotographing, and fw is the focal length of the entire optics during the wide-angle photographing.

The formula (7) defines conditions in which the lens optics, as a whole, can be downsized as well as reducing spherical aberration and field curvature in the zooming range. If (d2t−d2w)/(ft−fw) exceeds a lower limit defined in the formula (7) to be lower that it, especially, astigmatism develops more to degrade performance of the lens optics. If (d2t−d2w)/(ft−fw) exceeds a higher limit, especially, comatic aberration develops more to degrade the performance of the lens optics.

In still another aspect of the present invention, the infrared zoom lens meets the requirements as defined in the following formula (8):

−0.6<r3/ft<−0.2 (8)

where r3 is a radius of curvature of a circumferential surface zone of the second lens, and ft is a focal length of the entire optics during the telephotographing.

The formula (8) defines conditions in which the lens optics, as a whole, can be downsized as well as reducing comatic aberration in the zooming range. If r3/ft exceeds either a higher or lower limit defined in the formula (8) to be higher or lower than it, the comatic aberration is hard to correct.

In further another aspect of the present invention, all the lens pieces of the infrared zoom lens are made of a material of germanium.

With all the lens pieces made of germanium, the infrared zoom lens attains an effect of sufficiently small dispersion to suppress wavelength-dependent aberrations.

In yet another aspect of the present invention, the material of the lens pieces includes chalcogenide, germanium, and the like.

With all the lens pieces made of chalcogenide or germanium, the infrared zoom lens attains an effect of suppressing temperature-dependent transformation.

### BRIEF DESCRIPTION OF THE DRAWINGS

FIG. 1 is a cross-sectional view illustrating optical elements of a first embodiment of an infrared zoom lens according to the present invention.

FIG. 2 is a diagram illustrating spherical aberration in the first embodiment of the infrared zoom lens during the wide-angle photographing.

FIG. 3 is a diagram illustrating meridional comatic aberration in the first embodiment of the infrared zoom lens during the wide-angle photographing.

FIG. 4 is a diagram illustrating saggital comatic aberration in the first embodiment of the infrared zoom lens during the wide-angle photographing.

FIG. 5 is a diagram illustrating spherical aberration in the first embodiment of the infrared zoom lens during the telephotographing.

FIG. 6 is a diagram illustrating meridional comatic aberration in the first embodiment of the infrared zoom lens during the telephotographing.

FIG. 7 is a diagram illustrating saggital comatic aberration in the first embodiment of the infrared zoom lens during the telephotographing.

FIG. 8 is a cross-sectional view illustrating optical elements of a second embodiment of the infrared zoom lens according to the present invention.

FIG. 9 is a diagram illustrating spherical aberration in the second embodiment of the infrared zoom lens during the wide-angle photographing.

FIG. 10 is a diagram illustrating meridional comatic aberration in the second embodiment of the infrared zoom lens during the wide-angle photographing.

FIG. 11 is a diagram illustrating saggital comatic aberration in the second embodiment of the infrared zoom lens during the wide-angle photographing.

FIG. 12 is a diagram illustrating spherical aberration in the second embodiment of the infrared zoom lens during the telephotographing.

FIG. 13 is a diagram illustrating meridional comatic aberration in the second embodiment of the infrared zoom lens during the telephotographing.

FIG. 14 is a diagram illustrating saggital comatic aberration in the second embodiment of the infrared zoom lens during the telephotographing.

FIG. 15 is a cross-sectional view illustrating optical elements of a third embodiment of the infrared zoom lens.

FIG. 16 is a diagram illustrating spherical aberration in the third embodiment of the infrared zoom lens during the wide-angle photographing.

FIG. 17 is a diagram illustrating meridional comatic aberration in the third embodiment of the infrared zoom lens during the wide-angle photographing.

FIG. 18 is a diagram illustrating saggital comatic aberration in the third embodiment of the infrared zoom lens during the wide-angle photographing.

FIG. 19 is a diagram illustrating spherical aberration in the third embodiment of the infrared zoom lens during the telephotographing.

FIG. 20 is a diagram illustrating meridional comatic aberration in the third embodiment of the infrared zoom lens during the telephotographing.

FIG. 21 is a diagram illustrating saggital comatic aberration in the third embodiment of the infrared zoom lens during the telephotographing.

FIG. 22 is a cross-sectional view illustrating optical elements in a fourth embodiment of the infrared zoom lens according to the present invention.

FIG. 23 is a diagram illustrating spherical aberration in the fourth embodiment of the infrared zoom lens during the wide-angle photographing.

FIG. 24 is a diagram illustrating meridional comatic aberration in the fourth embodiment of the infrared zoom lens during the wide-angle photographing.

FIG. 25 is a diagram illustrating saggital comatic aberration in the fourth embodiment of the infrared zoom lens during the wide-angle photographing.

FIG. 26 is a diagram illustrating spherical aberration in the fourth embodiment of the infrared zoom lens during the telephotographing.

FIG. 27 is a diagram illustrating meridional comatic aberration in the fourth embodiment of the infrared zoom lens during the telephotographing.

FIG. 28 is a diagram illustrating saggital comatic aberration in the fourth embodiment of the infrared zoom lens during the telephotographing.

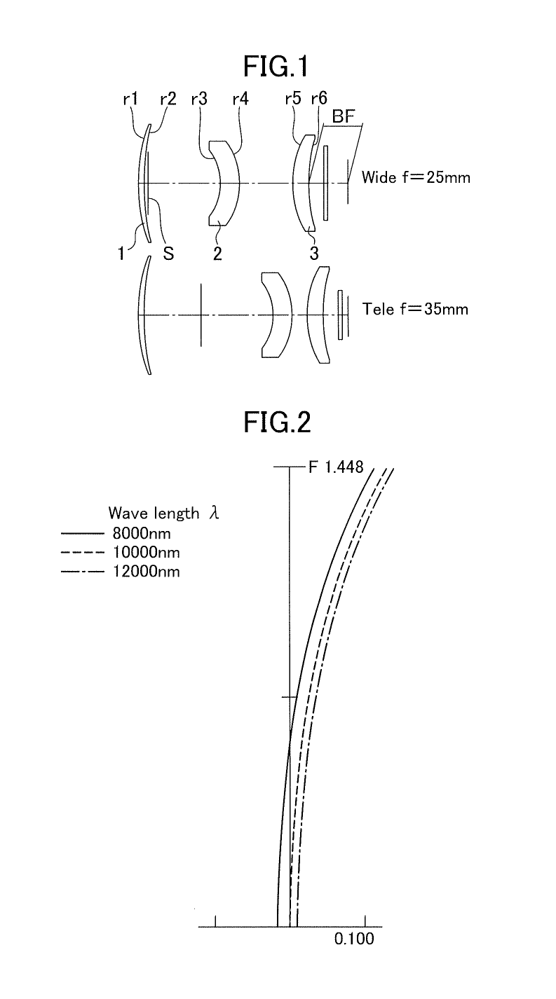

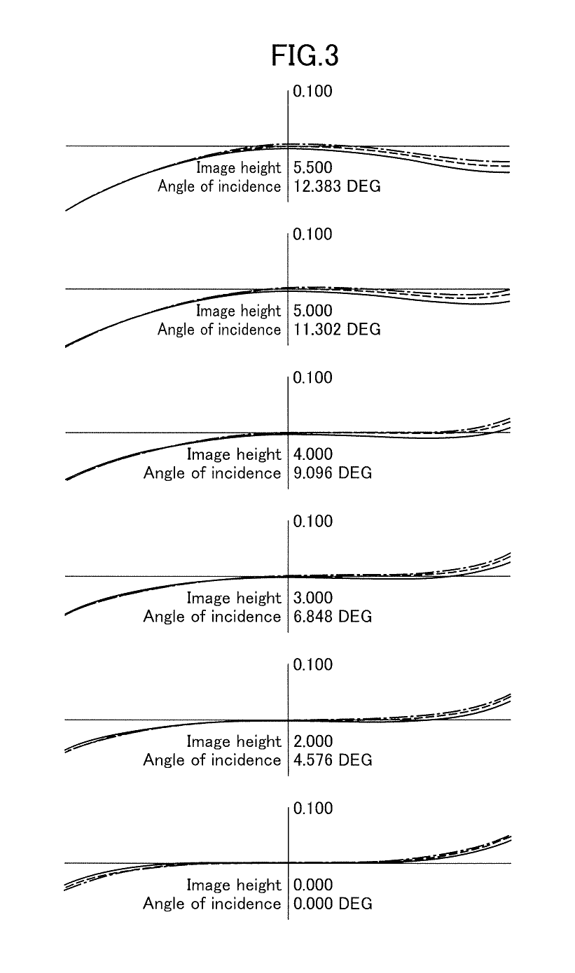

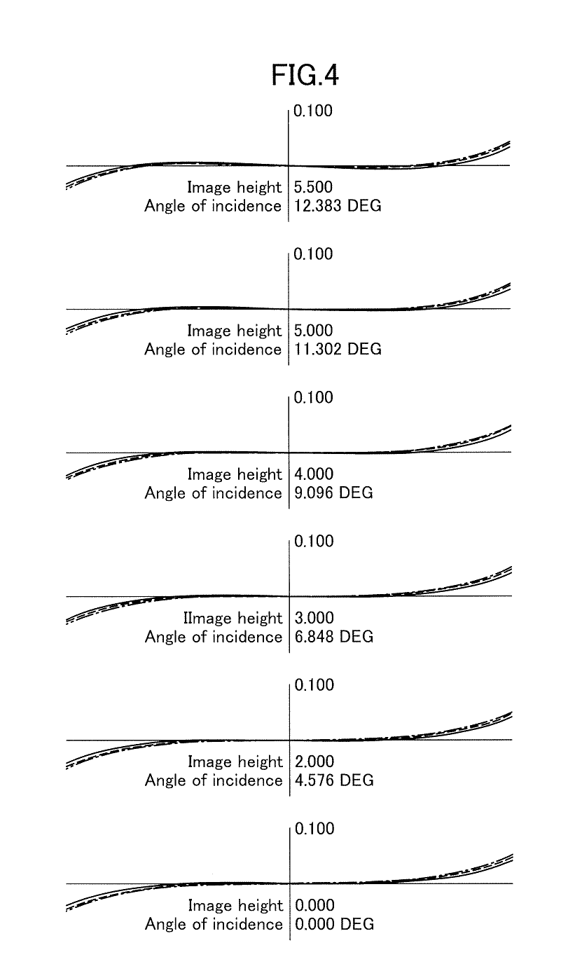

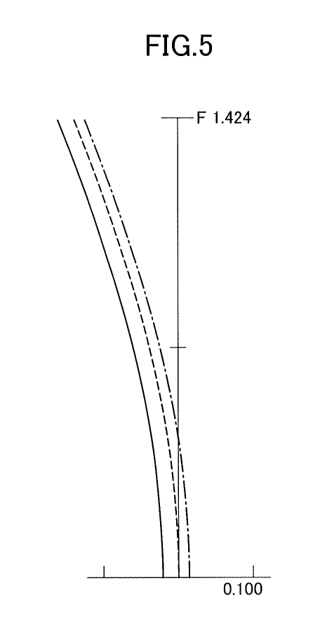

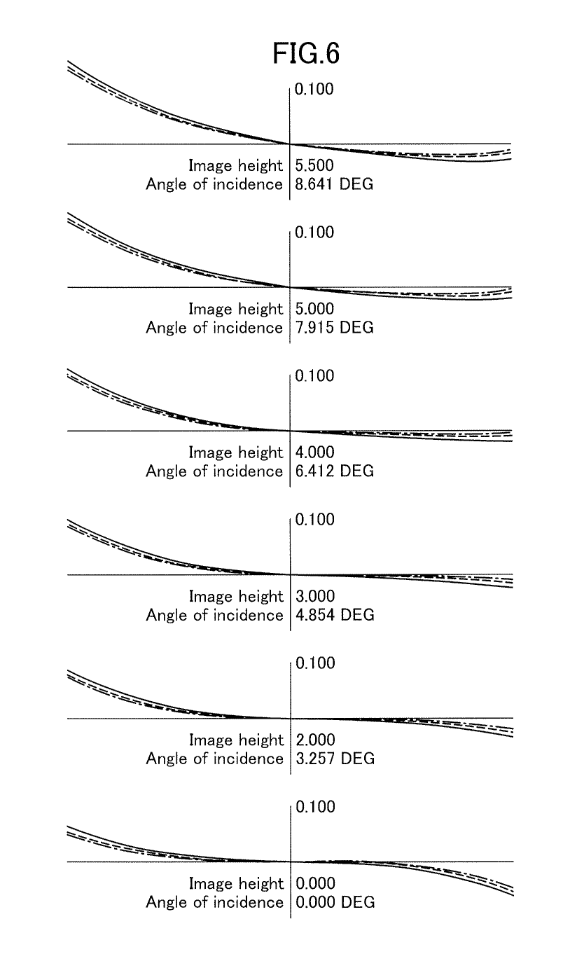

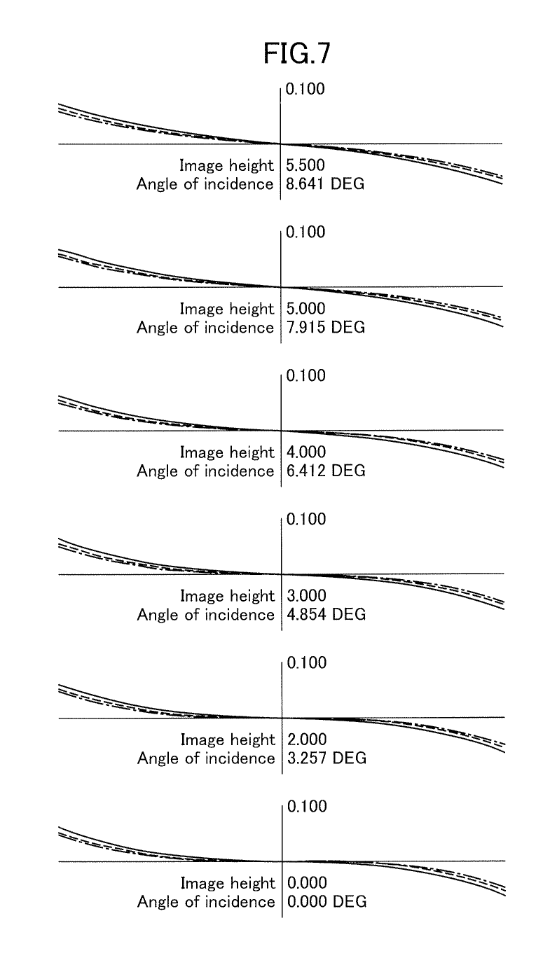

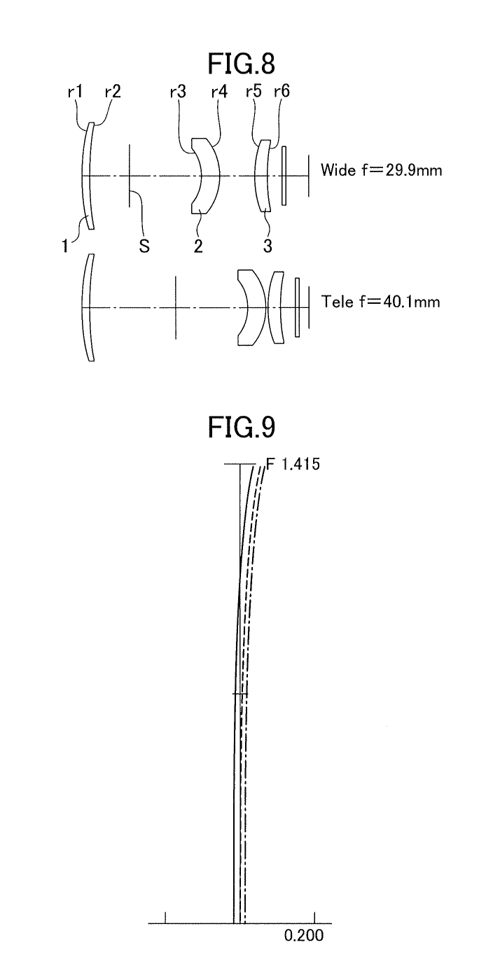

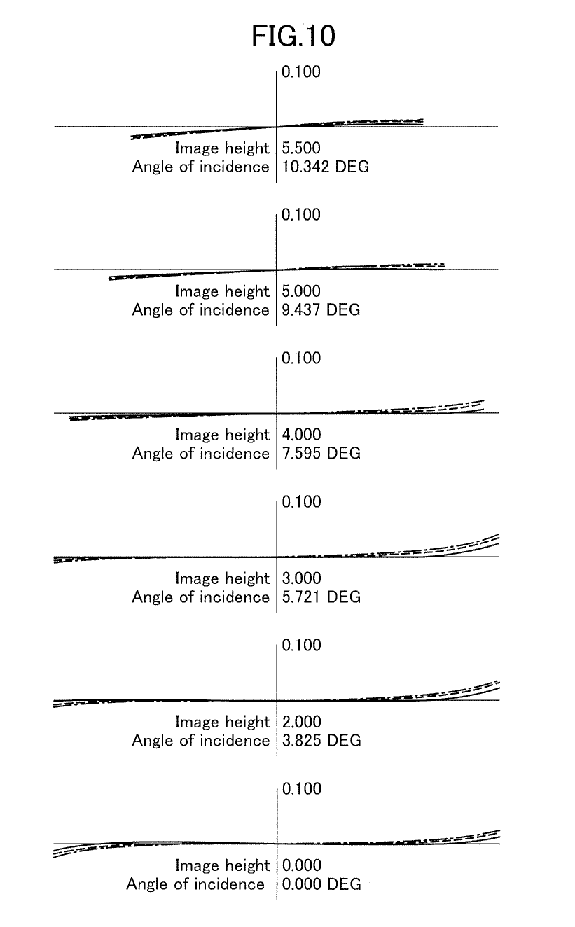

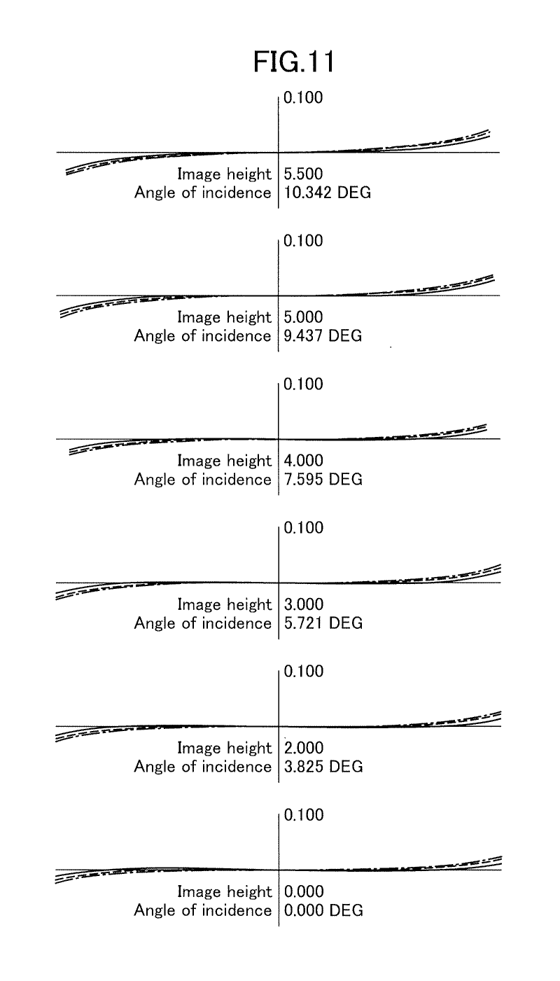

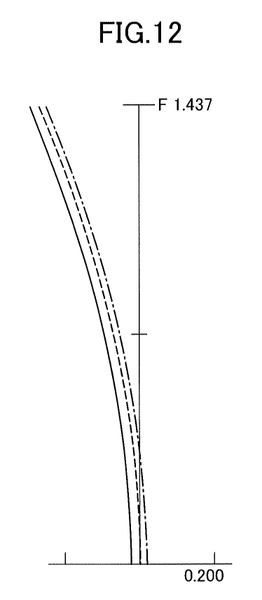

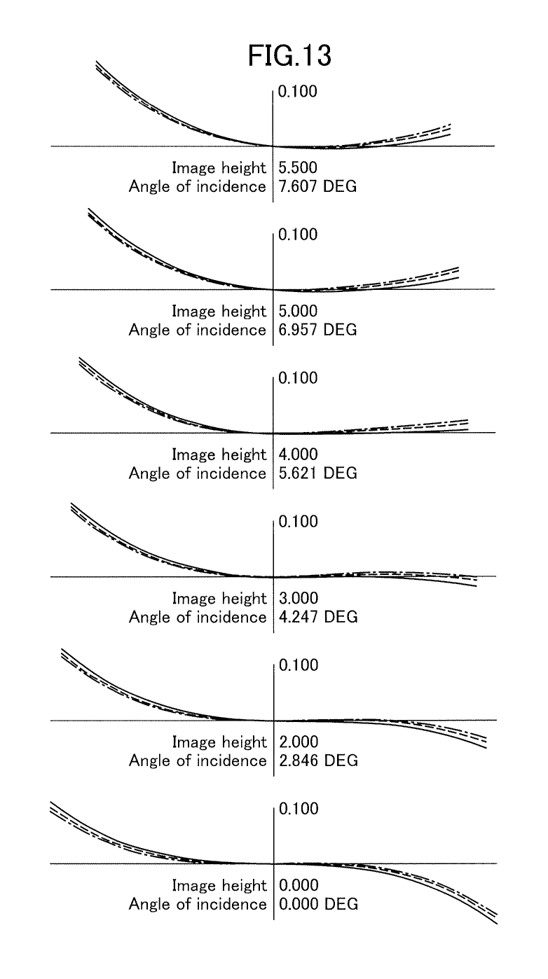

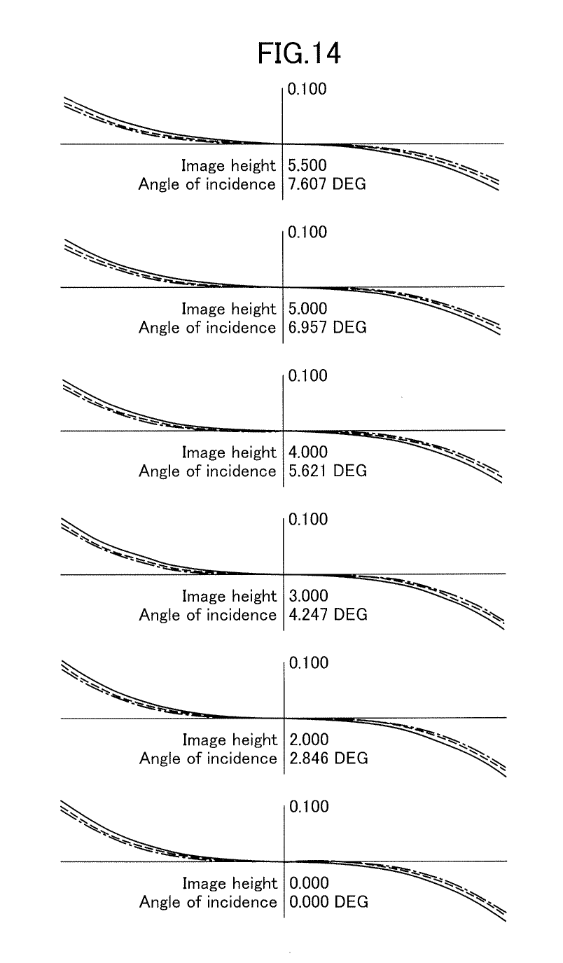

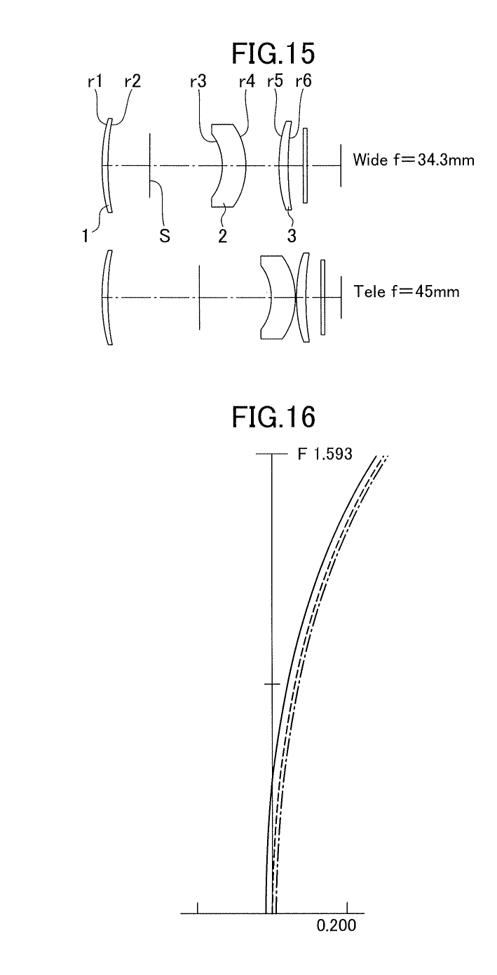

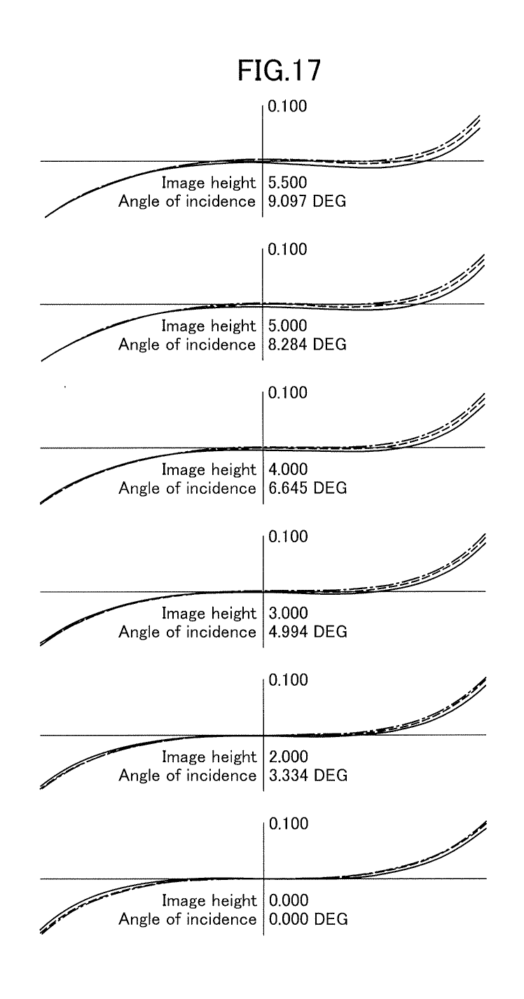

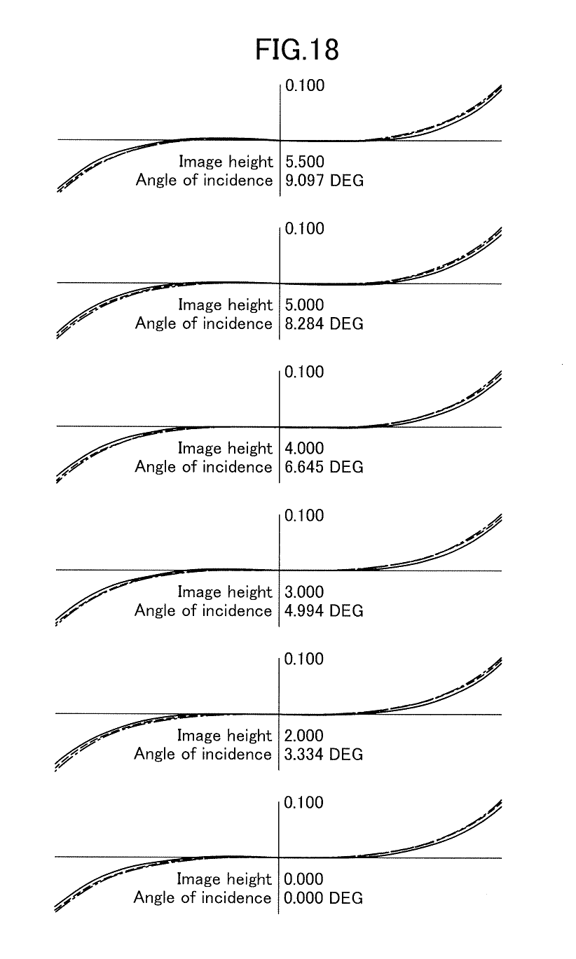

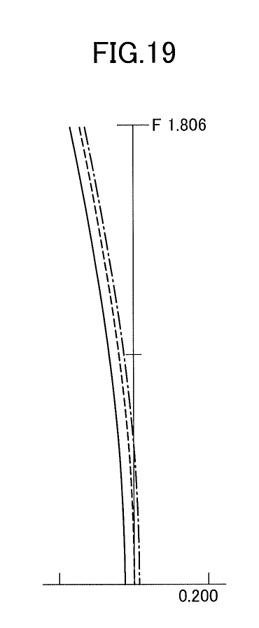

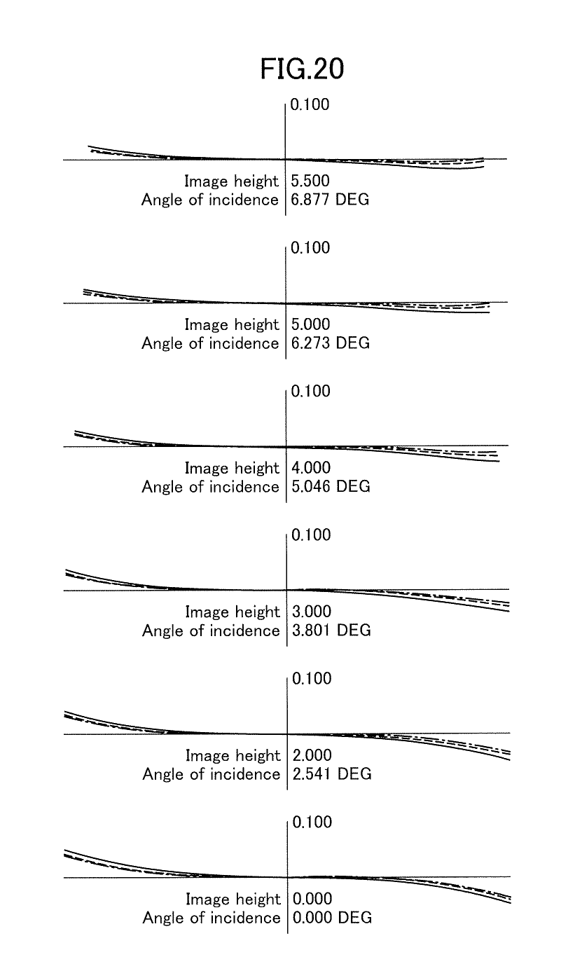

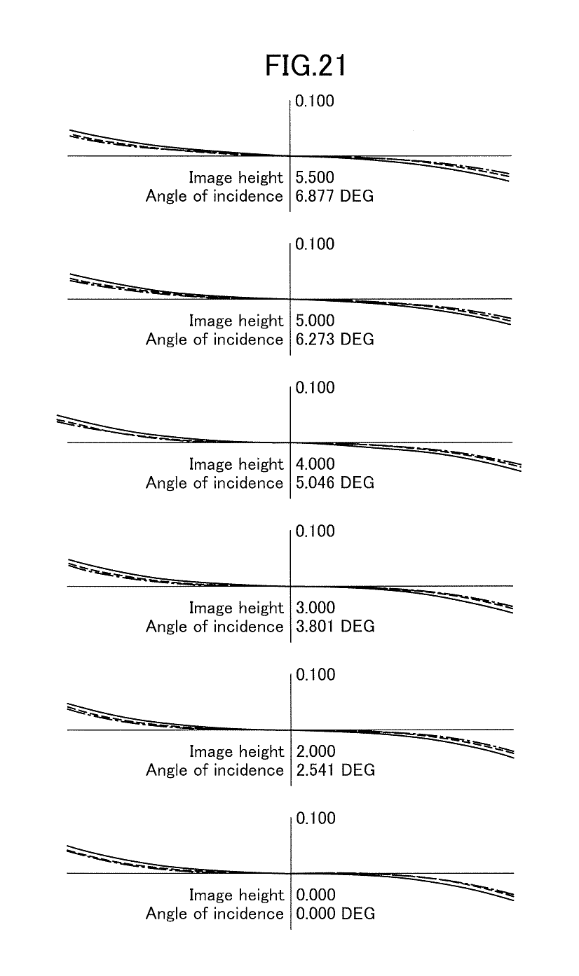

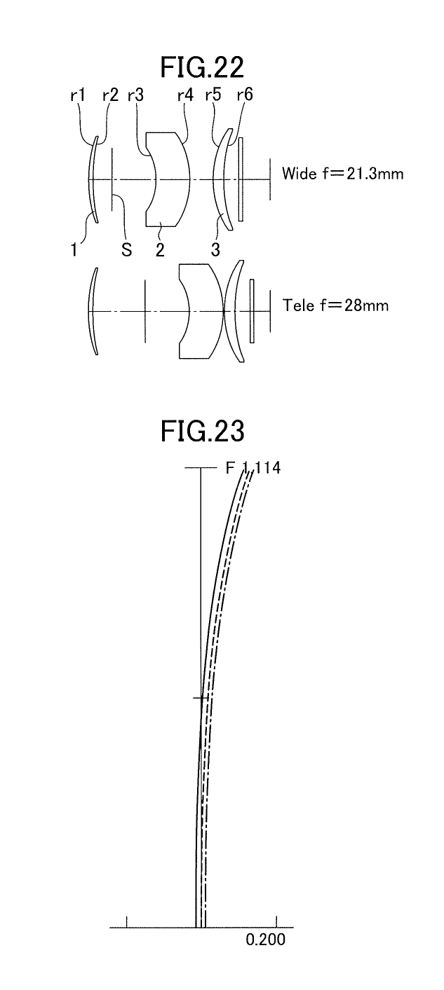

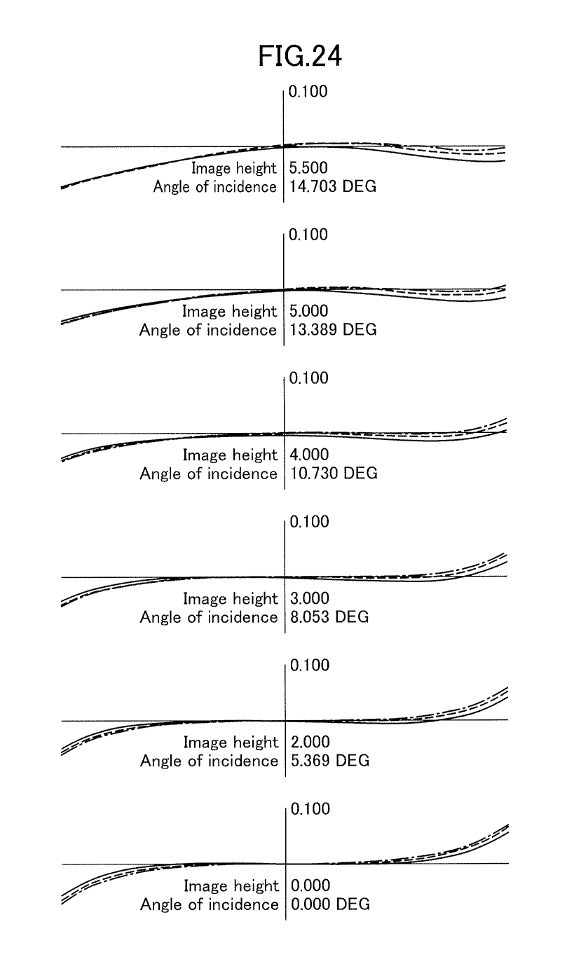

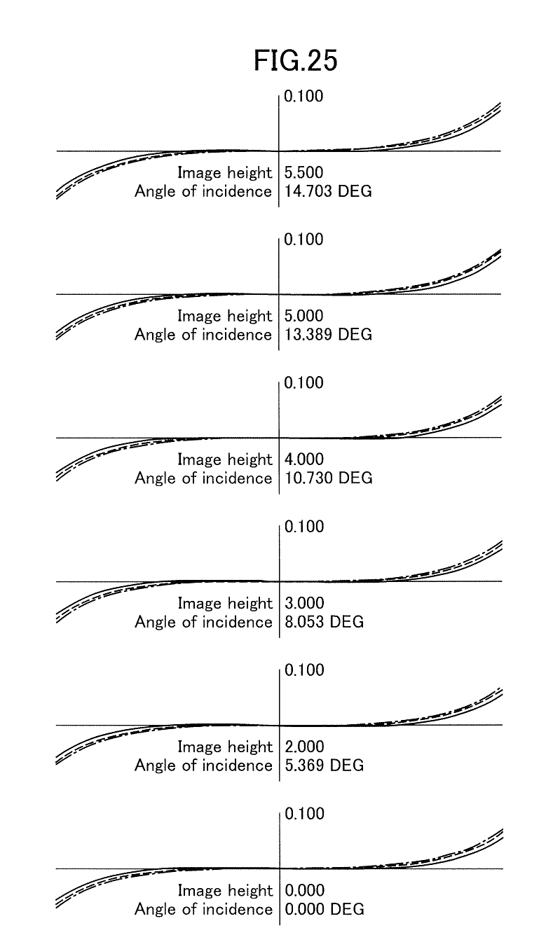

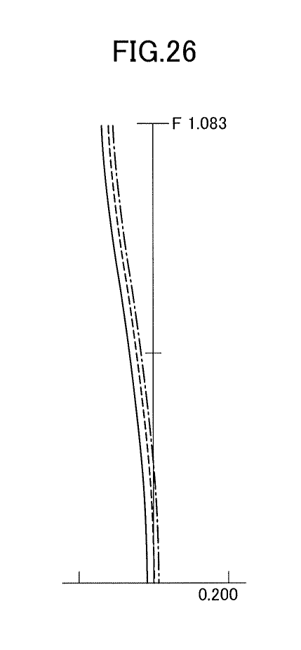

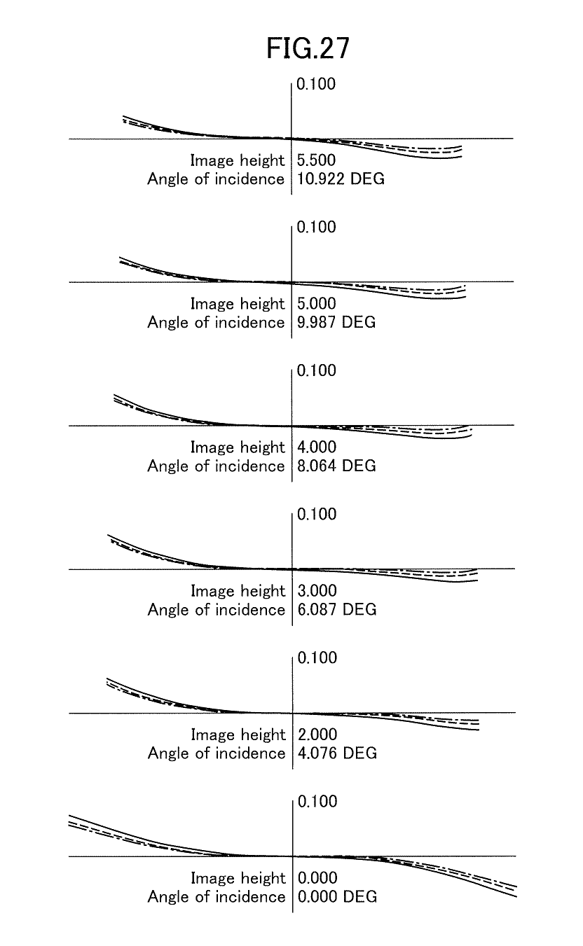

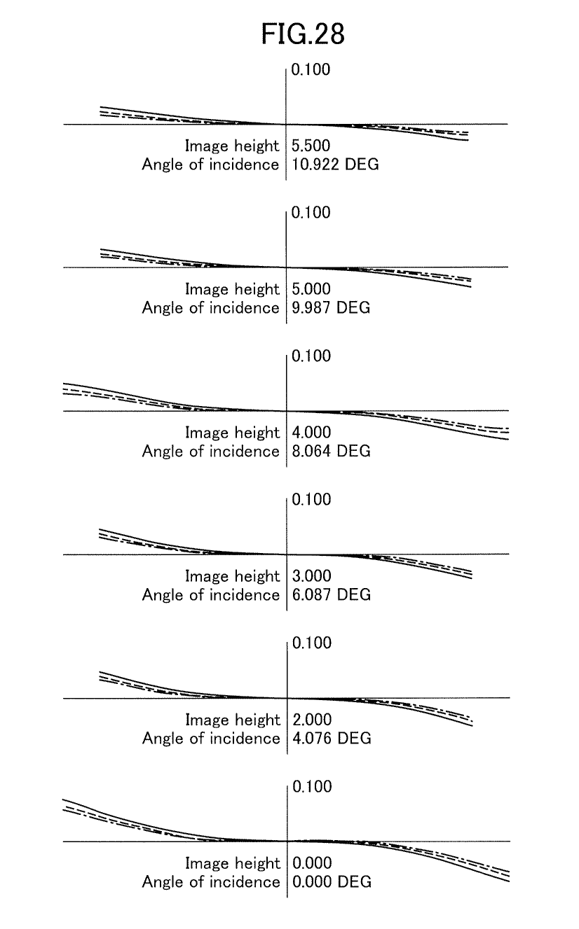

### DETAILED DESCRIPTION OF THE EMBODIMENTS

Lens property data of each of embodiments of an infrared zoom lens according to the present invention will be provided hereinafter. Refractive indices and focal lengths in the lens property data are all given as values with transmitted radiation of 10000 nm wavelength range.

### Embodiment 1

| | | | | Material | |
|---|---|---|---|---|---|
| Num. of | Radius of | Center | | (Refractive | Focal |
| Surface | Curvature | Thickness | Radius | Index) | Length |
| 1 | 46.5956 | 1.5 | 15.7 | Ge(4.0032) | 46.17 |
| 2 | 68.4825 | D2 | 15.6 | | |
| (Aperture Stop) | | 19.07 | 8.3 | | |
| 3 | −14.696 | 5.05 | 8.8 | Ge(4.0032) | −180.88 |
| 4 | −18.999 | D4 | 11.2 | | |
| 5 | 26.2705 | 4.24 | 12.8 | Ge(4.0032) | 18.27 |
| 6 | 44.3098 | 4.00 | 11.9 | | |
| 7 | ∞ | 1.00 | | Ge(4.0032) | |
| 8 | ∞ | D8 | | | |

<Zooming>

| | | Half Field | | | | Back |
|---|---|---|---|---|---|---|
| Focal | | of View | | | | Focus |
| Length | F/No | ω | D2 | D4 | D8 | BF |
| f = 25 | 1.44 | 12.42 | 1.0 | 14.18 | 5.29 | 10.29 |
| f = 35 | 1.42 | 8.63 | 15.0 | 3.98 | 1.49 | 6.49 |

<Values of Terms in the Formulae>

| | |
|---|---|
| Formula (6) | f1/ft = 1.319 |
| Formula (7) | (d2t − d2w)/(ft − fw) = 1.40 |
| Formula (8) | r3/ft = −0.42 |

### Embodiment 2

| Num. of | Radius of | Center | | Material | |
|---|---|---|---|---|---|
| Surface | Curvature | Thickness | Radius | (Refractive Index) | Focal Length |
| 1 | 56.1475 | 2.0 | 14.2 | Ge(4.0032) | 52.63 |
| 2 | 84.7523 | D2 | 14.0 | | |
| (Aperture Stop) | | 19.07 | 8.3 | | |
| 3 | −11.871 | 4.81 | 7.4 | Ge(4.0032) | −286.15 |
| 4 | −15.679 | D4 | 10.0 | | |
| 5 | 27.5545 | 3.32 | 9.5 | Ge(4.0032) | 18.27 |
| 6 | 46.2977 | 4.0 | 9.0 | | |
| 7 | ∞ | 1.0 | | Ge(4.0032) | |
| 8 | ∞ | D8 | | | |

<Zooming>

| | | Half Field | | | | Back |
|---|---|---|---|---|---|---|
| Focal | | of View | | | | Focus |
| Length | F/No | ω | D2 | D4 | D8 | BF |
| f = 29.9 | 1.41 | 10.34 | 10.49 | 9.29 | 6.06 | 11.06 |
| f = 40.1 | 1.44 | 7.57 | 22.69 | 0.56 | 2.59 | 7.59 |

<Values of Terms in the Formulae>

| | |
|---|---|
| Formula (6) | f1/ft = 1.312 |
| Formula (7) | (d2t − d2w)/(ft − fw) = 1.20 |
| Formula (8) | r3/ft = −0.30 |

### Embodiment 3

| | | | | Material | |
|---|---|---|---|---|---|
| Num. of | Radius of | Center | | (Refractive | Focal |
| Surface | Curvature | Thickness | Radius | Index) | Length |
| 1 | 48.4414 | 1.53 | 12.5 | Ge(4.0032) | 55.84 |
| 2 | 66.5054 | D2 | 12.5 | | |
| (Aperture Stop) | | 19.07 | 8.5 | | |
| 3 | −14.312 | 6.34 | 8.5 | chal(2.5861) | −180.55 |
| 4 | −19.158 | D4 | 11.0 | | |
| 5 | 37.9423 | 2.45 | 11.8 | Ge(4.0032) | 24.06 |
| 6 | 76.0365 | 4.0 | 11.5 | | |
| 7 | ∞ | 1.0 | | Ge(4.0032) | |
| 8 | ∞ | D8 | | | |

<Zooming>

| | | Half Field | | | | Back |
|---|---|---|---|---|---|---|
| Focal | | of View | | | | Focus |
| Length | F/No | ω | D2 | D4 | D8 | BF |
| f = 24.3 | 1.59 | 9.12 | 11.3 | 8.75 | 8.94 | 13.94 |
| f = 45.0 | 1.85 | 6.87 | 24.08 | 0.31 | 4.33 | 9.33 |

<Values of Terms in the Formulae>

| | |
|---|---|
| Formula (6) | f1/ft = 1.241 |
| Formula (7) | (d2t − d2w)/(ft − fw) = 1.22 |
| Formula (8) | r3/ft = −0.32 |

### Embodiment 4

| | | | | Material | |
|---|---|---|---|---|---|
| Num. of | Radius of | Center | | (Refractive | Focal |
| Surface | Curvature | Thickness | Radius | Index) | Length |
| 1 | 35.0788 | 1.1 | 11.5 | Ge(4.0032) | 36.96 |
| 2 | 50.0814 | D2 | 11.4 | | |
| (Aperture Stop) | | 11.71 | 8.3 | | |
| 3 | −14.971 | 8.96 | 8.5 | Ge(4.0032) | −226.2 |
| 4 | −22.181 | D4 | 12.5 | | |
| 5 | 24.4545 | 2.78 | 13.5 | Ge(4.0032) | 20.33 |
| 6 | 37.3168 | 4.0 | 13.0 | | |
| 7 | ∞ | 1.0 | | Ge(4.0032) | |
| 8 | ∞ | D8 | | | |

<Zooming>

| | | Half Field | | | | Back |
|---|---|---|---|---|---|---|
| Focal | | of View | | | | Focus |
| Length | F/No | ω | D2 | D4 | D8 | BF |
| f = 21.3 | 1.11 | 14.73 | 4.98 | 6.19 | 7.88 | 12.22 |
| f = 28 | 1.08 | 7.57 | 13.82 | 0.31 | 4.26 | 9.26 |

<Values of Terms in the Formulae>

| | |
|---|---|
| Formula (6) | f1/ft = 1.320 |
| Formula (7) | (d2t − d2w)/ (ft − fw) = 1.32 |
| Formula (8) | r3/ft = −0.53 |

1. An infrared zoom lens comprising the first lens of a single positive-powered lens piece, the second lens of a single negative-powered lens piece, and the third lens of a single positive-powered lens piece, all the lens pieces being spherical lenses, and the infrared zoom lens having its first lens staying still in a fixed position and its second and third lens moved along the optical axis for the zooming.

2. The infrared zoom lens according to claim 1, wherein the infrared zoom lens meets the requirement as defined in the following formula:
f1/ft<1.5
where f1 is a focal length of the first lens, and ft is the focal length of the entire optics during the telephotographing.

3. The infrared zoom lens according to claim 1, wherein the infrared zoom lens meets the requirements as defined in the following formula:
1.0<(d2t−d2w)/(ft−fw)<1.5
where d2t is a distance from the first lens to the second lens during the telephotographing, d2w is the distance from the first lens to the second lens during the wide-angle photographing, ft is a focal length of the entire optics during the telephotographing, and fw is the focal length of the entire optics during the wide-angle photographing.

4. The infrared zoom lens according to claim 1, wherein the infrared zoom lens meets the requirements as defined in the following formula:
−0.6<r3/ft<−0.2
where r3 is a radius of curvature of a circumferential surface zone of the second lens, and ft is a focal length of the entire optics during the telephotographing.

5. The infrared zoom lens according to claim 1, wherein all the lens pieces of the infrared zoom lens are made of a material of germanium.

6. The infrared zoom lens according to claim 1, wherein the material of the lens pieces includes chalcogenide, germanium, and the like.
